(19) United States
(12) Patent Application Publication
(10) Pub. No.: US 2011/0078311 A1
(43) Pub. Date: Mar. 31, 2011

(54) Network communication device and automatic reconnection method

(75) Inventor: Jun Nakashima, Osaka (JP)

(73) Assignee: OKI ELECTRIC INDUSTRY CO., LTD., Tokyo (JP)

(21) Appl. No.: 12/801,931

(22) Filed: Jul. 2, 2010

(30) Foreign Application Priority Data
Sep. 29, 2009 (JP) 2009-224845

(51) Int. Cl. G06F 21/20; G06F 15/173

(52) U.S. Cl. 709/225

(57) ABSTRACT

As a defense against cyber attacks, a network communication device permits other communication devices to associate and undergo entity authentication, registers the identifiers of devices that pass entity authentication in a memory, and communicates only with those devices. As a further defense, the network communication device may also impose association control by normally refusing to let other communication devices even associate. The network communication device monitors the communicability of devices with identifiers registered in the memory. If communication with a device becomes disabled, its identifier is removed from the memory and placed in a whitelist. Whitelisted devices may re-associate even while association control is in effect. A device that experiences outage may therefore re-associate autonomously, without requiring human intervention.

### BACKGROUND OF THE INVENTION

1. Field of the Invention

The present invention relates to a network communication device with association control, and to an automatic reconnection method.

2. Description of the Related Art

The term ‘association’ is used in this application to mean an initial exchange of information between two communication devices made in order for the devices to set up a connection and begin communicating. The set-up process typically includes agreement on a shared encryption key.

It is generally preferable for the communication devices in a closed secure network to accept connections only from authorized communication devices. The association process therefore includes a so-called entity authentication procedure.

Entity authentication can prevent unauthorized access, but cannot easily prevent denial-of-service (DoS) attacks. In a typical DoS attack a malicious communication device repeatedly sends association requests to a router device, giving different addresses, all of which fail authentication. But a large amount of authentication processing uses up so much of the router device's computing resources that it cannot serve association requests from the legitimate communication devices properly.

An alternative defense strategy is an association control scheme in which normally all association requests sent to the router device are summarily rejected without going through the association process. When a new connection needs to be set up, a network administration communication device, often a hand-held device, is used to disable association control temporarily. At this point, a communication device that has finished a successful association process with the router device can communicate with the router device without the association process unless it loses the encryption key and other parameter that {were} set up in the association process.

The problem is how to disable association control when a third communication device that is already legitimately connected to the router device loses its encryption key, for example, and needs to re-associate. In such a situation, association control must be disabled by the control unit as above. In a wireless LAN for home use, association control may be performed only at one access point, but in a large-scale sensor/control network including a plurality of routers, association control is performed at each router, posing a problem of scalability. To disable association control, the failed communication device and the router or routers with which it needs to associate must be identified, creating a huge administrative task. It would be preferable for communication devices in this type of network to be able to re-associate autonomously even when association is restricted.

In Japanese Patent Application Publication No. 2007-13348, Ishidoshiro discloses another method, in which a wireless communication device accepts just one arbitrary association request while a button is depressed. This method defeats denial-of-service attacks that attempt to take advantage of association, because a third party'cannot detect the time at which the user depresses the button.

Depressing a button is an improvement in user convenience, but this method still requires human intervention to bypass association control.

### SUMMARY OF THE INVENTION

An object of the present invention is to enable a legitimate communication device to re-associate autonomously, even when association is restricted.

The invention provides a network communication device to which other communication devices connect by first associating with the network communication device and undergoing entity authentication. The network communication device includes an association control unit for restricting association by allowing or denying association by arbitrary communication devices from which association requests are received through a network, and a registered communication device memory for storing identifiers of communication devices that have passed the entity authentication after being allowed to associate. Communication devices whose identifiers are stored in the registered communication device memory can communicate with the network communication device without having to re-associate because they have set up the shared encryption key and the other parameters.

A connection status monitoring unit monitors the feasibility of communication with the communication devices registered in the registered communication device memory. If it detects to disconnect with (a) communication device, the identifier of that communication device(s) is/are removed from the registered communication device memory and placed in an association whitelist memory. Communication devices whose identifiers are stored in the association whitelist memory may associate with the network communication device regardless of association control, even if the association control unit is denying requests for association by all other communication devices.

If a malicious communication device whose identifier is present in the association whitelist memory but who has no legitimate authentication information to be authorized fails entity authentication a predetermined number of times, an invalidating mark may be attached to its identifier in the association whitelist memory to prevent further association by the same communication device. The invalidating marks may be cleared at predetermined intervals, such as once a day. When the legitimate communication device passes entity authentication, its identifier is preferably removed from the association whitelist memory and it is registered in the registered communication device memory again according to the association process.

These provisions enable the network communication device to defeat denial-of-service attacks while still permitting a legitimate communication device to re-associate autonomously after temporary outage.

### BRIEF DESCRIPTION OF THE DRAWINGS

In the attached drawings:

FIG. 1 is a block diagram showing the structure of a network communication device in a first embodiment of the invention;

FIG. 2 is a block diagram showing the structure of a legitimate communication device in the first embodiment;

FIG. 3 is a block diagram showing the structure of a malicious communication device in the first embodiment;

FIG. 4 is a flowchart illustrating the operation of the network communication device in FIG. 1;

FIG. 5 is a flowchart illustrating the operation of the network communication device in a second embodiment of the invention;

FIG. 6 is a flowchart illustrating the invalidating mark clearing operation;

FIG. 7 is a block diagram showing the structure of a network communication device in a third embodiment of the invention; and

FIG. 8 is a flowchart illustrating the operation of the network communication device in FIG. 7.

### DETAILED DESCRIPTION OF THE INVENTION

Embodiments of the invention will now be described with reference to the attached drawings, in which like elements are indicated by like reference characters.

### First Embodiment

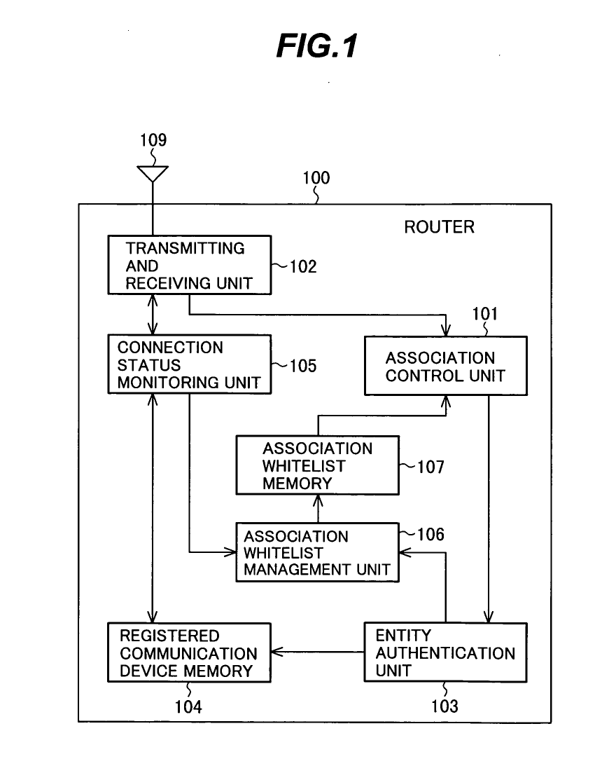

The network communication device in the first and second embodiments is node device, more specifically a router, that will also be used as a first router in the third embodiment. Referring to FIG. 1, this router 100 includes an association control unit 101, a transmitting and receiving unit 102, an entity authentication unit 103, a registered communication device memory 104, a connection status monitoring unit 105, an association whitelist management unit 106, and an association whitelist memory 107. The transmitting and receiving unit 102 is connected internally to the association control unit 101 and the connection status monitoring unit 105, and externally via an antenna 109 to a communication network (not shown).

The association control unit 101 is an association allowability decision means that decides whether or not to accept a received association request and begin the association process. In this embodiment, when the transmitting and receiving unit 102 receives a request to disable association control via the antenna 109 from a network administration device (not shown), it disables association control temporarily. Association control can be resumed after interruption by some appropriate means: for example, association control can be resumed after a predetermined time interval measured by a timer (not shown), after reception of a single association request, or after reception of a predetermined number of association requests as counted by a counter (not shown). Alternatively, association control can be disabled while a button provided in a button interface is depressed. The association control unit 101 also has a filtering function that enables it to sort association requests and unconditionally accept association requests from communication devices with identifiers stored in the association whitelist memory 107.

The transmitting and receiving unit 102 functions as a transmitter and receiver for communicating with other communication devices. The transmitting and receiving unit 102 also encrypts data to be transmitted, decrypts and authenticates received data, and manages parameters such as sequence numbers pertaining to communication with devices with which the association process has been completed.

The entity authentication unit 103 is an entity authentication decision means, connected to the association control unit 101, that executes a prescribed authentication protocol to validate authentication information received from a communication device that issues an association request. The authentication information includes the address of the communication device.

The registered communication device memory 104 is a registered communication device storage facility. It is connected to the entity authentication unit 103 and stores an identifier, such as the address, of each communication device that has been successfully authenticated by the entity authentication unit 103. The identifier should include a code or number by which the communication device can be uniquely identified.

The connection status monitoring unit 105 is connected to the transmitting and receiving unit 102, registered communication device memory 104, and association whitelist management unit 106 and manages the status of connections. The connection status monitoring unit 105 monitors the status of connections with communication devices whose identifiers are stored in the registered communication device memory 104. When a connection with a device is lost, the connection status monitoring unit 105 sends the identifier (for example, address) of that communication device to the association whitelist management unit 106. Connection status can be monitored by any appropriate method: for example, in the case of ad-hoc wireless network using the Optimized Link State Routing (OLSR) protocol, it can be decided that a connection has been lost when a Hello packet is not received. Alternatively, it can be decided that a connection has been lost when an answer to a query is not obtained.

The association whitelist management unit 106 is connected to the association whitelist memory 107. The association whitelist management unit 106 is an association whitelist control means, and the association whitelist memory 107 is an association whitelist storage facility.

When the association whitelist management unit 106 receives, from the connection status monitoring unit 105, the identifier of a communication device that has lost its connection, it stores the identifier in the association whitelist memory 107. When a reassociation request is received from a communication device that has lost its connection, if entity authentication succeeds, the association whitelist management unit 106 deletes the identifier of that communication device from the association whitelist memory 107.

The association whitelist memory 107 is connected to the association control unit 101, and provides the association control unit 101 with the identifiers of communication devices that are allowed to associate with the router 100.

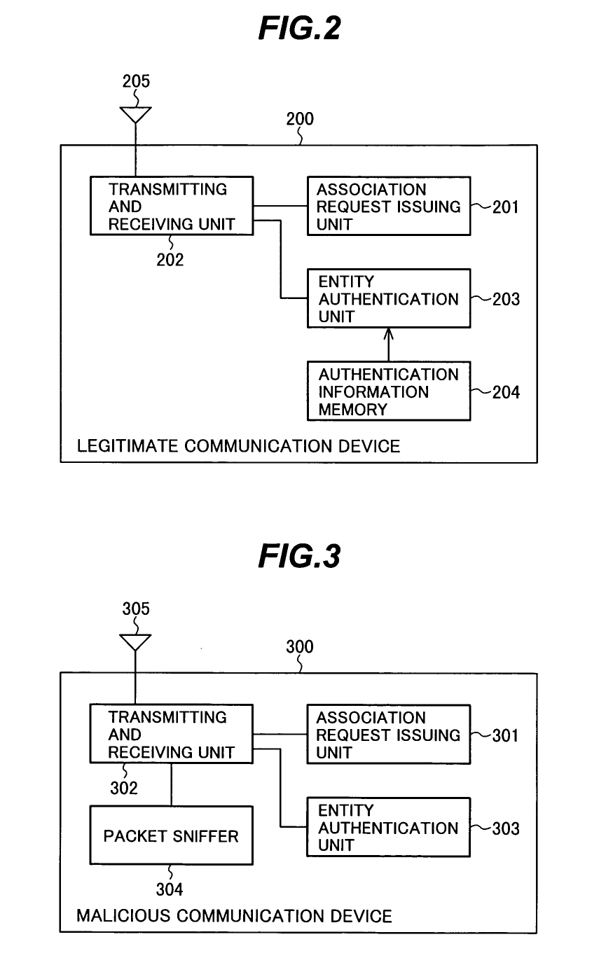

FIG. 2 is a block diagram showing the structure of a legitimate communication device 200 in the first embodiment. The communication device 200 comprises an association request issuing unit 201, a transmitting and receiving unit 202, an entity authentication unit 203, and an authentication information memory 204. The transmitting and receiving unit 202 is connected to the association request issuing unit 201 and the entity authentication unit 203.

The association request issuing unit 201 selects a device with which to associate, issues an association request, and provides the association request to the transmitting and receiving unit 202 for transmission to the selected device.

The transmitting and receiving unit 202 is wirelessly connectable to the network via an antenna 205, and has functions for transmitting data to and receiving data from arbitrary communication devices. These functions include encryption of data to be transmitted, decryption and authentication of received data, and management of sequence numbers.

The entity authentication unit 203 is connected to the authentication information memory 204 and executes the entity authentication process with the device to which the association request is issued, using authentication information stored in the authentication information memory 204.

The authentication information memory 204 stores authentication information for use in entity authentication.

A malicious node or malicious communication device 300 that does not possess authentication information but transmits frequent association requests has the structure shown in FIG. 3. The malicious communication device 300 comprises an association request issuing unit 301, a transmitting and receiving unit 302, an entity authentication unit 303, and a packet sniffer 304. The transmitting and receiving unit 302 is connected to the association request issuing unit 301, the entity authentication unit 303, and the packet sniffer 304.

The association request issuing unit 301 selects a target router device and issues an appropriate association request.

The transmitting and receiving unit 302 is connectable wirelessly to the network via an antenna 305, and has the functions of transmitting and receiving data.

The entity authentication unit 303 is in possession of the relevant entity authentication protocol but lacks the necessary authentication information, so authentication practically never succeeds.

The packet sniffer 304 eavesdrops on network traffic by, for example, analyzing the non-encrypted address information fields of packets to identify the addresses of nearby communication devices.

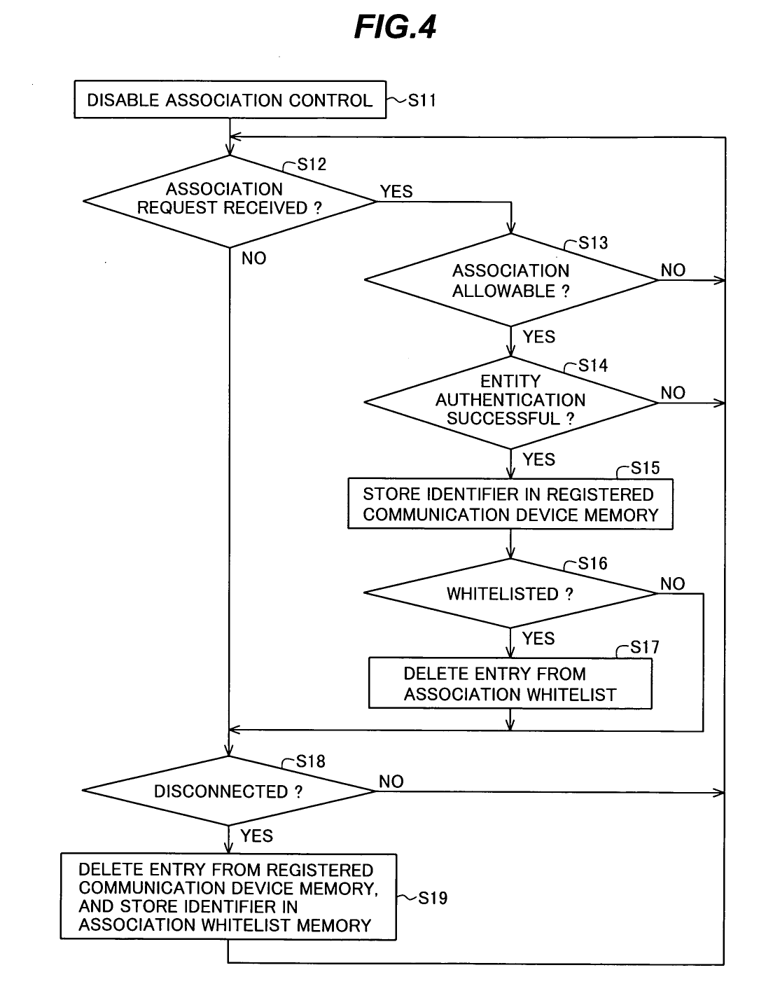

Next, the operation of the router 100 will be described with reference to the flowchart in FIG. 4.

In this description, the router 100 is a component of a wireless ad-hoc network, and the legitimate communication device 200 tries to connect to the router 100 to join the network. The malicious communication device 300 is a malicious router that mounts a denial-of-service attack by repeatedly sending association requests to the router 100.

First, an installer installs the legitimate communication device 200, which possesses authentication information, within communication range of the router 100. Next, using a handheld wireless device such as a network administration device, the installer sends an encrypted control-disabling command to the router 100. The transmitting and receiving unit 102 in the router 100 receives and decrypts this command, and sends it to the association control unit 101, which temporarily disables association control (step S11). When the communication device 200 is powered up, the transmitting and receiving unit 102 in the router 100 receives an association request issued by the association request issuing unit 201 in the communication device 200 (Yes in step S12). Since association control has been temporarily disabled, the association control unit 101 decides that association is allowable and accepts the association request (Yes in step S13). The entity authentication unit 103 and the entity authentication unit 203 in the communication device 200 then execute entity authentication (step S14).

Entity authentication may be performed by an authentication server instead of the router 100. In that case the router 100 only relays packets between the communication device 200 and the authentication server, and receives the authentication result from the authentication server.

If entity authentication succeeds (Yes in step S14), the router 100 stores the address of the legitimate communication device 200 as an identifier in the registered communication device memory 104 (step S15). The router 100 and the communication device 200 initialize respective sequence numbers, agree on a shared encryption key, and set other necessary communication parameters. The communication device 200 stores the encryption key and sequence number it uses for communication with the router 100 in a random access memory (RAM, not shown).

After these steps, association control is re-enabled, and only devices listed in the association whitelist memory 107 are allowed to associate. Communication device 200 is not currently listed in the association whitelist memory 107, but communication device 200 has set up the shared encryption key and other parameters required to communicate with the router 100, so communication device 200 can continue to communicate with the router 100 without having to re-associate each time.

Suppose now that at some time after connecting and becoming able to communicate, communication device 200 experiences outage, temporarily loses power, and can neither transmit nor receive. The encryption keys and sequence numbers stored in the RAM are also lost.

The connection status monitoring unit 105 in the router 100 detects that communication with communication device 200 has become impossible (Yes in step S18), and reports the address of communication device 200 to the association whitelist management unit 106. The connection status monitoring unit 105 deletes the entry (address or other identifier) of communication device 200 from the registered communication device memory 104, and the association whitelist management unit 106 immediately stores the address of communication device 200 in the association whitelist memory 107 (step S19).

Later, communication device 200 recovers power, restarts, and tries to reconnect with the router 100.

Communication device 200 discovers the router 100 by access to its address, and the association request issuing unit 201 issues an association request to the router 100. The association control unit 101 in the router 100 refers to the association whitelist memory 107, finds the address of communication device 200 listed there (‘whitelisted’), decides to allow communication device 200 to associate (Yes in step S13), and calls on the entity authentication unit 103. The entity authentication unit 103 in the router 100 and the entity authentication unit 203 in communication device 200 then execute entity authentication. When authentication succeeds (Yes in step S14), the address of communication device 200 is again stored in the registered communication device memory 104 (step S15) and the association whitelist management unit 106 deletes the address of communication device 200 from the association whitelist memory 107 (steps S16 and S17).

Suppose now that the malicious communication device 300 initiates a denial-of-service (DoS) attack by eavesdropping on the communication network, discovering the address of the legitimate communication device 200, and issuing frequent association requests to the router 100, giving the address of the legitimate communication device 200. Since association control is in effect and the address of the legitimate communication device 200 is not stored in the association whitelist memory 107, when each of these association requests is received, the association control unit 101 in the router 100 checks the association whitelist memory 107, fails to find the given address, and rejects the association request (No in step S13) without initiating the association process.

By rejecting all association requests from the malicious communication device 300 in this simple way, the router 100 can avoid the comparatively heavy communication and computation loads that would arise if it were to execute the authentication protocol. Nevertheless, if the legitimate communication device 200 experiences a failure, when it recovers, the router 100 can accept a reassociation request from the legitimate communication device 200 without having to receive a control-disabling command from the network administration device, because the address of the legitimate communication device 200 is temporarily stored in the association whitelist memory 107.

Each of the addresses or other identifiers stored in the association whitelist memory 107 in the first embodiment may have an expiration limit. For example, if an association request is not received from communication device 200 for a predefined period (one hour, for example) after storage of the identifier of communication device 200 in the association whitelist memory 107, the association whitelist management unit 106 may delete this identifier from the association whitelist memory 107.

### Second Embodiment

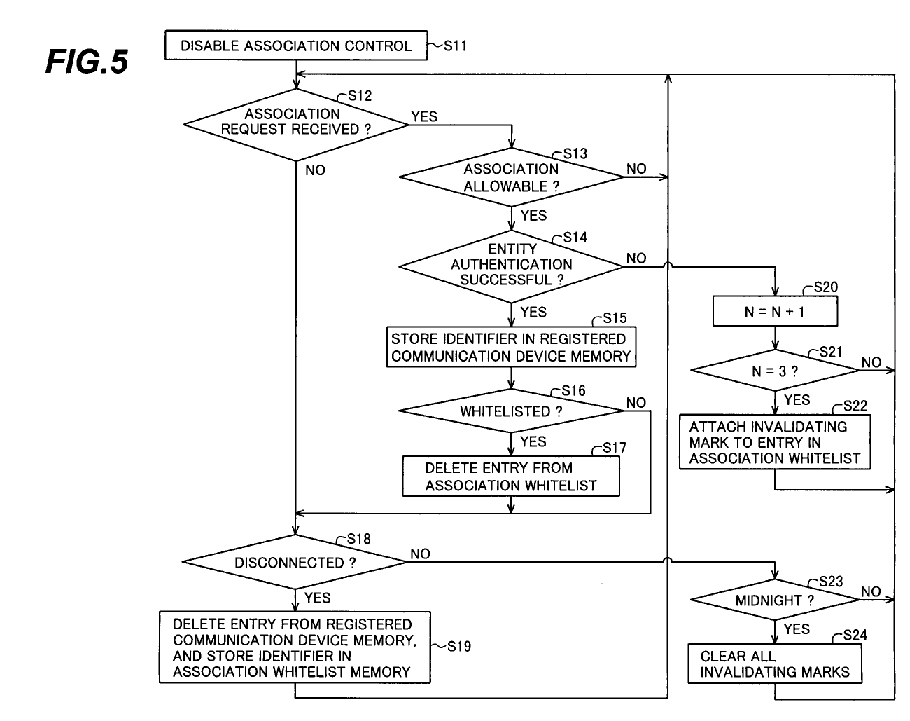

A modification of the operation of the router 100 is illustrated in FIG. 5 as a second embodiment of the invention. The router 100 has the same structure as in FIG. 1, but the whitelist management policy and the policy management functions of the association whitelist management unit 106 are modified.

The whitelist management policy now includes the following provisions:

A1—The identifier of a communication device that has completed successful'entity authentication is deleted from the association whitelist (this was done in step S17 in the first embodiment).

A2—If a communication device with an identifier that has been registered in the association whitelist fails the authentication protocol three times, an invalidating mark is temporally added to the entry of the communication device.

A3—An association request from a communication device marked with an invalidating mark is rejected even though the identifier of the communication device has been registered in the association whitelist.

A4—Invalidating marks are removed once per day.

The association control unit 101 accordingly rejects association requests from a communication device that has already failed entity authentication three times within the current day.

The communication device 200 and malicious communication device 300 have the same structure as in the first embodiment, so the reference characters in FIGS. 1 to 3 will be used without change in the following description of operation in the second embodiment.

First, the installer installs the legitimate communication device 200, which possesses authentication information, within communication range of the router 100. Next, using a handheld wireless device, the installer temporarily disables association control in the router 100 (step S11). When the legitimate communication device 200 is powered up, the transmitting and receiving unit 102 in the router 100 receives an association request issued by the association request issuing unit 201 in the communication device 200 (Yes in step S12). Since association control has been disabled, the association control unit 101 decides that association is allowable and accepts the association request (Yes in step S13), and the entity authentication units 103, 203 in the router 100 and communication device 200 execute entity authentication (step S14).

As in the first embodiment, entity authentication may be performed by an authentication server instead of the router 100.

If entity authentication succeeds (Yes in step S14), the router 100 stores the address of the legitimate communication device 200 as an identifier in the registered communication device memory 104 (step S15). The router 100 and communication device 200 initialize respective sequence numbers to zero and agree on a shared encryption key for communication.

Suppose that an attacker now intentionally blocks communication with the legitimate communication device 200. The connection status monitoring unit 105 detects that the router 100 cannot communicate with communication device 200 (Yes in step S18), and sends the address of communication device 200 to the association whitelist management unit 106. The association whitelist management unit 106 immediately stores the address of communication device 200 in the association whitelist memory 107 (step S19).

The attacker now activates the malicious communication device 300 and the malicious communication device 300 transmits an association request to the router 100, giving the address of the legitimate communication device 200. In step S13, the association control unit 101 in the router 100 refers to the association whitelist memory 107, discovers the address of the legitimate communication device 200, confirms invalidating mark is cleared, and calls on the entity authentication unit 103, which executes entity authentication. Since the malicious communication device 300 lacks legitimate authentication information, authentication fails (No in step S14). The association whitelist management unit 106 immediately increments the authentication failure count N of the legitimate communication device 200 in the association whitelist memory 107 from its initial value of zero to one (step S20). After step S20, the association whitelist management unit 106 decides if the authentication failure count N has reached three or not (step S21). If the authentication failure count N is two or less, a return is made to step S12 to receive the next association request.

In a denial-of-service attack, association requests may be repeated with the same address but different randomly selected authentication information. Following this strategy, the malicious communication device 300 sends another association request to the router 100, again giving the address of the legitimate communication device 200, but entity authentication fails again. The association whitelist management unit 106 increments the authentication failure count N for communication device 200 to two (step S20).

The malicious communication device 300 then transmits a third association request to the router 100, still giving the address of the legitimate communication device 200, and entity authentication fails once again. The association whitelist management unit 106 increments the authentication failure count N for communication device 200 to three, and attaches an invalidating mark to the identifier of communication device 200 in the association whitelist, following provision A2 in the whitelist management policy.

The invalidation threshold in the whitelist management policy is not limited to a failure count of three; the threshold failure count may be'four, for example.

If the malicious communication device 300 continues to send association requests to the router 100, still giving the address of the legitimate communication device 200, the association control unit 101 continues to reject them, because the identifier of communication device 200 is marked with an invalidating mark in the association whitelist, so no further entity authentication is executed.

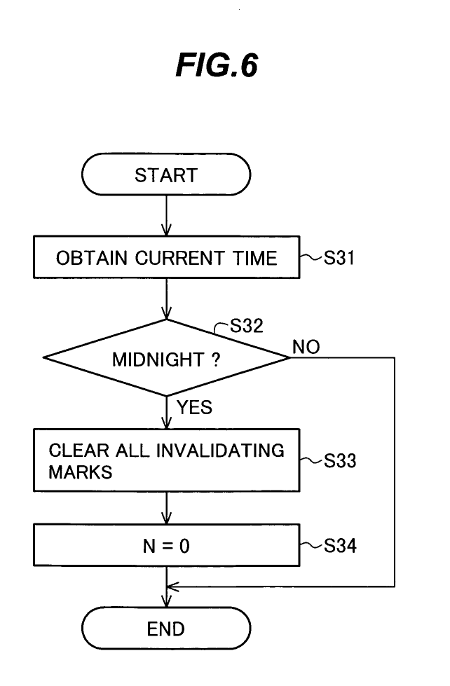

In addition to conducting the association operations shown in FIG. 5, the association whitelist management unit 106 in the router 100 obtains the current time (step S31 in FIG. 6) from a real-time clock (not shown). When the time is midnight (Yes in step S32), the association whitelist management unit 106, following provision A4 of the whitelist management policy, clears all invalidating marks in the association whitelist memory 107 (step S33) and initializes the corresponding authentication failure counts to zero (step S34). The invalidating mark attached to the identifier of communication device 200 is thereby cleared, and its authentication failure count N is reset to zero.

Alternatively, these steps may be carried out in the basic loop in FIG. 5. When no association request is received and no new disconnection is detected (No in steps S12 and S18), the time is checked (step S23). If the time is midnight (Yes in step S23), the association whitelist management unit 106 clears all invalidating marks in the association whitelist memory 107 and initializes the corresponding authentication failure counts to zero (step S24) as specified in provision A4 of the whitelist management policy.

The invalidating marks do not have to be cleared at midnight. Invalidating marks can be cleared at a different time of day, or in response to a condition other than the time of day. The condition should, however, allow sufficient time for the malicious node to be eliminated and for the communication device 200 to recover its communication capability.

After the legitimate communication device 200 has recovered its communication capability and after the invalidating mark has been cleared from the association whitelist memory 107, or after the legitimate communication device 200 has recovered its communication capability and before the authentication failure count has reached the threshold level of three, if the legitimate communication device 200 sends an association request to the router 100, the request is accepted and entity authentication succeeds as in the first embodiment. The association whitelist management unit 106 in the router 100 then deletes the entry of the legitimate communication device 200 from the association whitelist, as specified by provision A1 in the whitelist management policy (step S17 in FIG. 5).

The second embodiment is effective against the type of denial-of-service attack that maliciously disables the legitimate communication device 200, then waits for enough time for the address of communication device 200 to be stored in the association whitelist memory 107 and repeatedly sends association requests to the router 100, giving the address of communication device 200. Provisions A2 and A3 of the whitelist management policy minimize the damage caused by this type of DoS attack. While the invalidating mark is set, network administration personnel have time to investigate the site, find the malicious communication device and identify the attacker, and thoroughly eliminate the problem.

In a variation of the structure of the router 100 in the first embodiment, communication disconnection marks are attached to entries in the registered communication device memory 104, without providing an association whitelist memory 107, and association requests are accepted from communication devices marked as disconnected in the registered communication device memory 104. In this variation, invalidating marks can also be attached to the entries in the registered communication device memory 104 as in the second embodiment, so that association requests are accepted only from communication devices with valid disconnection marks.

### Third Embodiment

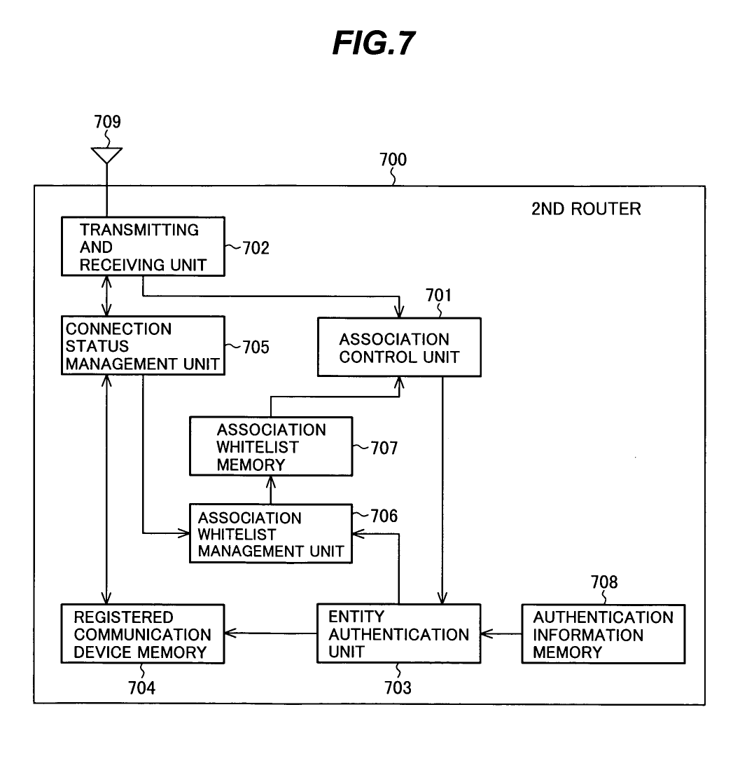

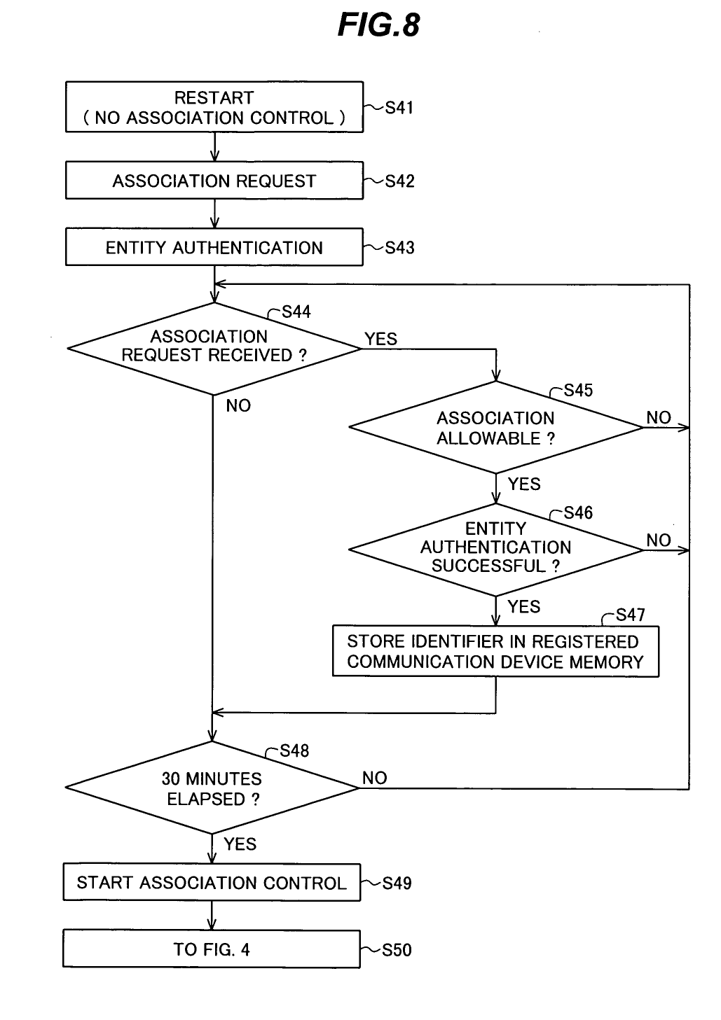

The third embodiment uses a second router 700 shown in FIG. 7. The router 100 shown in FIG. 1 is also used, and will now be referred to as the first router.

The second router 700 includes an association control unit 701, a transmitting and receiving unit 702, an entity authentication unit 703, a registered communication device memory 704, a connection status monitoring unit 705, an association whitelist management unit 706, and an association whitelist memory 707, which are similar to the association control unit 101, transmitting and receiving unit 102, entity authentication unit 103, registered communication device memory 104, connection status monitoring unit 105, association whitelist management unit 106, and association whitelist memory 107 in the first router device 100 in FIG. 1, and are interconnected in the same way. The transmitting and receiving unit 702 is connected to an antenna 709.

The second router 700 also has a nonvolatile authentication information memory 708. The authentication information memory 708 is connected to the entity authentication unit 703 and stores authentication information pertaining to the second router 700.

A new policy management function is added to the association control unit 701. The following policy provisions are preset in the association control unit 701:

B1—Association control is temporarily disabled on reception of an association-control disabling command from a network administration device (this was done in step S13 in the first embodiment).

B2—When an association request is received from a communication device, if the identifier of the communication device is stored without an invalidating mark in the association whitelist memory 707, entity authentication of the device may be carried out.

B3—Association control is disabled for thirty minutes after start-up, and enabled when thirty minutes have elapsed.

Next, the operation of the second router 700 will be described with reference to the flowchart in FIG. 8. In this description, it is assumed that the second router 700 is connected to the router 100 and the legitimate communication device 200 is connected to the second router 700.

It is furthermore assumed that the second router 700 experiences a power failure, and then restarts automatically after recovering power, but that during the power failure, the second router 700 loses the communication parameters it was using to communicate with both the first router 100 and the legitimate communication device 200.

When the second router 700 restarts (step S41), it issues an association request to the first router 100 (step S42). The first router 100 operates as described in the first embodiment: the association control unit 101 refers to the association whitelist memory 107 and finds an entry for the second router 700 (Yes in step S13 in FIG. 4), and the entity authentication unit 103 executes entity authentication (step S14 in FIG. 4).

The second router 700 reads its own authentication information from the authentication information memory 708 and submits this information to the first router 100, and entity authentication succeeds (step S43 in FIG. 8). The first and second routers 100, 700 then select communication parameters and the second router 700 rejoins the network. Steps S42 and S43 are typically completed in less than one minute, so at this point, association control in the second router 700 is still disabled.

The time at which association control begins is a design choice and is not limited to thirty minutes after start-up. The time is counted by a timer (not shown).

In the meantime, the legitimate communication device 200 has lost its connection and is attempting periodically to reconnect to the second router 700. Within a few minutes of rejoining the network, the second router 700 receives an association request from communication device 200 (Yes in step S44). Less than thirty minutes have elapsed since the second router 700 restarted, so association control is still disabled. The association control unit 701 therefore decides that association is allowable and the association request is accepted (Yes in step S45). The entity authentication units 203, 703 in communication device 200 and the second router 700 execute entity authentication (step S46). When entity authentication succeeds (Yes in step S46), the entity authentication unit 703 in the second router 700 stores an identifier of communication device 200, such as its address, in the registered communication device memory 704 (step S47).

When the second router 700 detects from its timer that thirty minutes have elapsed from the point of recovery (Yes in step S48), the association control unit 701 begins association control (step S49). The second router 700 now (step S50) operates as described in the first or second embodiment, accepting association requests only from communication devices with valid entries in the association whitelist memory 707.

The third embodiment enables a communication device to do reassociaion autonomously following outage either at the communication device itself or at the router to which the communication device was connected when the outage occurred. Following outage at the router, the communication device only has to issue an association request within a predetermined time (e.g., 30 minutes) after the router is restored to service.

In a variation of the third embodiment, the thirty-minute duration begins when the second router 700 completes entity authentication with the first router 100 and rejoins the network.

Although the network in the preceding embodiments is wireless, the invention is applicable to wired networks as well.

The association control unit 101, entity authentication unit 103, registered communication device memory 104, connection status monitoring unit 105, association whitelist management unit 106, and association whitelist memory 107 in FIG. 1 may be implemented in a computing device in which the association control unit 101, entity authentication unit 103, connection status monitoring unit 105, and association whitelist management unit 106 may be software components stored in a machine-readable medium. The computing device may also include a nonvolatile memory, part of which is used as the authentication information memory 708.

Those skilled in the art will recognize that further variations are possible within the scope of the invention, which is defined in the appended claims.

What is claimed is:

1. A network communication device to which other communication devices connect by first associating with the network communication device and undergoing entity authentication, the network communication device comprising:
an association control unit for restricting association by deciding whether an arbitrary communication device, from which an association request has been received through a network, may or may not associate with the network communication device;
an entity authentication unit for deciding, after the association control unit has decided that the arbitrary communication device may associate with the network communication device, whether entity authentication of the arbitrary communication device succeeds or fails;
a registered communication device memory for storing an identifier identifying the arbitrary communication device if the entity authentication unit decides that entity authentication of the arbitrary communication device succeeds;
a connection status monitoring unit for monitoring feasibility of communication with the arbitrary communication device and deleting the identifier identifying the arbitrary communication device from the registered communication device memory if communication with the arbitrary communication device is detected to have become impossible; and
an association whitelist management unit for storing the identifier identifying the arbitrary communication device in an association whitelist memory when the connection status monitoring unit detects that communication with the arbitrary communication device is impossible;
wherein
if the identifier identifying the arbitrary communication device is stored in the association whitelist memory, the association control unit decides that the arbitrary communication device may associate with the network communication device, even when association is restricted.

2. The network communication device of claim 1, wherein:
the association whitelist management unit counts failures of entity authentication of the arbitrary communication device as determined by the entity authentication unit, and if the identifier identifying the arbitrary communication device is stored in the association whitelist memory, the association whitelist management unit also stores an invalidating mark in the association whitelist memory when the arbitrary communication device fails entity authentication a predetermined number of times; and
when association is restricted, the association control unit decides that the arbitrary communication device may associate with the network communication device only if the identifier identifying the arbitrary communication device is stored in the association whitelist memory without an invalidating mark.

3. The network communication device of claim 2, wherein the association whitelist management unit deletes all invalidating marks from the association whitelist memory at predetermined intervals.

4. The network communication device of claim 3, wherein the predetermined intervals are one-day intervals.

5. The network communication device of claim 1 wherein, if the identifier identifying the arbitrary communication device is stored in the association whitelist memory, the association whitelist management unit deletes the identifier identifying the arbitrary communication device from the association whitelist memory when the entity authentication unit decides that entity authentication of the arbitrary communication device succeeds.

6. The network communication device of claim 1 wherein, if the identifier identifying the arbitrary communication device has been stored in the association whitelist memory for a predetermined period and no association request has been received from the arbitrary communication device during the predetermined period, the association whitelist management unit deletes the identifier identifying the arbitrary communication device from the association whitelist memory.

7. The network communication device of claim 1, wherein the identifier is an address of the arbitrary communication device.

8. The network communication device of claim 1, wherein the network communication device is a router, and after experiencing outage and restarting, the network communication device waits for a predetermined time before starting to restrict association.

9. The network communication device of claim 8, wherein the predetermined time begins when the network communication device restarts.

10. The network communication device of claim 8, wherein the predetermined time begins when the network communication device succeeds in entity authentication and establishes a connection with another router.

11. An autonomous reconnection method for a network communication device to which other communication devices connect by first associating with the network communication device and undergoing entity authentication, the autonomous reconnection method comprising:
restricting association by deciding whether an arbitrary communication device, from which an association request has been received through a network, may or may not associate with the network communication device;
deciding, after it has been decided that the arbitrary communication device may associate with the network communication device, whether entity authentication of the arbitrary communication device succeeds or fails;
storing an identifier identifying the arbitrary communication device in a registered communication device memory if entity authentication of the arbitrary communication device succeeds;
monitoring feasibility of communication with the arbitrary communication device and deleting the identifier identifying the arbitrary communication device from the registered communication device memory if communication with the arbitrary communication device is detected to have become impossible; and
storing the identifier identifying the arbitrary communication device in an association whitelist memory when it is detected that communication with the arbitrary communication device has become impossible; wherein
when the identifier identifying the arbitrary communication device is stored in the association whitelist memory, the arbitrary communication device may associate with the network communication device unconditionally.
